(19) United States
(12) Patent Application Publication
(10) Pub. No.: US 2007/0029140 A1
(43) Pub. Date: Feb. 8, 2007

(54) Series progressive lubricant metering device

(75) Inventor: Thomas S. Smigelski, Twinsburg, OH (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Lubriquip, Inc.

(21) Appl. No.: 11/197,902

(22) Filed: Aug. 5, 2005

(51) Int. Cl. F16N 7/02

(52) U.S. Cl. 184/81

(57) ABSTRACT

A lubricant metering device comprised of a housing having an opening formed therein. The housing has an inlet port communicating with the opening and a plurality of outlet ports communicating with the opening. An insert is disposed within the opening. A plurality of valve spools is provided within the insert, each valve spool being reciprocally movable within a bore in the insert. Fluid passages are formed in the insert. The fluid passage connects the inlet port in the housing to each bore in the insert, connects each bore to the other bore in the insert, and connects each bore to at least one outlet port in the housing, wherein each spool will move in sequence to dispense a metered quantity of lubricant to an outlet port, as long as lubricant under pressure is applied to the inlet port.

### FIELD OF THE INVENTION

The present invention relates generally to the field of lubrication, more particularity to a lubricating device that is designed to cyclically operate to meter and dispense in a sequence a predetermined quantity of lubricant to a number of different locations.

### BACKGROUND OF THE INVENTION

Lubricating devices that are capable of operating cyclically to meter and dispense a predetermined quantity of lubricant to a plurality of locations in a sequence are commonly referred to in the art as series progressive divider valves. Most often, such devices are constructed of a number of separate valve blocks that are sandwiched between an inlet block unit and an end block unit, with all units being held together by bolts. Each valve block includes a movable spool and a plurality of fluid passages that communicate with the spool and extend to the surface of the valve blocks. The fluid passages within the valve blocks are disposed to be in registry with the fluid passages in adjacent valve blocks and with fluid passages formed within the inlet block unit and the outlet block unit, such that when assembled together the spools within the valve blocks operate cyclically to meter and discharge a predetermined quantity of lubricant to a number of outlet ports in a predetermined sequence. U.S. Pat. No. 4,312,425 to Snow et al. and U.S. Pat. No. 5,480,004 to Snow are examples of series progressive divider valves of the type heretofore described.

The operation of a series progressive lubricant metering device is similar to an automobile engine that keeps firing one cylinder after another as long as fuel and sparks are applied. In a series progressive lubricant metering device, the pistons in three or more intermediate sections of the divider valve move back and forth in a continuous cycle, forcing the lubricant successively through the several outlets, as long as lubricant is supplied under pressure at the inlet.

As will be appreciated from a review of the aforementioned patents, a substantial amount of machining is required to manufacture the inlet block, the end block and each valve block. Moreover, assembly requires accurate and precise seating of O-rings between the respective blocks such that the aligned fluid passages through the respective blocks maintain fluid-type connections. In this respect, significant cost and time is involved in manufacturing and assembly of series progressive divider valves known heretofore.

The present invention provides an improved series progressive lubricant metering device having fewer movable parts and that is less costly to manufacture.

### SUMMARY OF THE INVENTION

In accordance with a preferred embodiment of the present invention, there is provided a lubricant metering device comprised of a housing having an opening formed therein. The housing has an inlet port communicating with the opening and a plurality of outlet ports communicating with the opening. An insert is disposed within the opening. A plurality of valve spools is provided within the insert, each valve spool being reciprocally movable within a bore in the insert. Fluid passages are formed in the insert. The fluid passage connects the inlet port in the housing to each bore in the insert, connects each bore to the other bore in the insert, and connects each bore to at least one outlet port in the housing, wherein each spool will move in sequence to dispense a metered quantity of lubricant to an outlet port, as long as lubricant under pressure is applied to the inlet port.

In accordance with another embodiment of the present invention, there is provided a progressive, sequential lubricant metering device comprised of a housing having an opening formed therein. The opening defines an inner surface within the housing. A fluid inlet in the housing communicates with the opening. “N” number of fluid outlets in the housing communicates with the opening. An insert is disposed within the opening in the housing. The insert has “n” number of bored openings formed therein, where “N” is twice “n.” A reciprocally movable valve element is disposed in each of the bored openings. A plurality of fluid passages connects each bored opening to the other bored opening and connects each bored opening to a fluid outlet, wherein each of the valve elements will move in sequence to dispense a metered quantity of lubricant to an outlet, as long as lubricant under pressure is applied to the inlet port.

An advantage of the present invention is a series progressive metering device for cyclically metering and discharging a predetermined quantity of lubricant to a plurality of locations in a sequence.

Another advantage of the present invention is a series progressive metering device as described above having fewer parts than series progressive divider valves known heretofore.

Another advantage of the present invention is a series progressive metering device as described above that is less costly and is easier to manufacture than series progressive divider valves known heretofore.

Another advantage of the present invention is a series progressive metering device as described above that is more compact than series progressive divider valves known heretofore.

A further advantage of the present invention is a series progressive metering device as described above that may be formed as part of, or within, the mechanical structure to be lubricated.

A further advantage of the present invention is a series progressive metering device as described above that is comprised of a housing and an insert within the housing, wherein all movable parts are disposed within the insert.

Yet another advantage of the present invention is a series progressive metering device as described above wherein valve elements within the device are replaceable to vary the amounts of lubricant dispensed by the device.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a perspective view of a series progressive lubricant metering device illustrating a preferred embodiment of the present invention;

FIG. 2 is an exploded view of the series progressive lubricant metering device shown in FIG. 1;

FIG. 3 is a sectional view taken along lines 3-3 of FIG. 1;

FIG. 4 is a pictorial representation of a prior art series progressive lubricant metering device;

FIG. 5 is a perspective view of an insert for use in the series progressive lubricant metering device shown in FIG. 1, showing one end and side of the insert;

FIG. 6 is a perspective view of an insert for use in the series progressive lubricant metering device shown in FIG. 1, showing the same end and the other side of the insert;

FIG. 7 is a developed view of the surface of the insert;

FIG. 8 is a sectional view taken along lines 8-8 of FIG. 7;

FIG. 9 is a sectional view taken along lines 9-9 of FIG. 7;

FIG. 10 is a sectional view taken along lines 10-10 of FIG. 7;

FIG. 11 is a sectional view taken along lines 11-11 of FIG. 7;

FIG. 12 is a sectional view taken along lines 12-12 of FIG. 7;

FIG. 13 is a sectional view taken along lines 13-13 of FIG. 7; and

FIG. 14 is a sectional view taken along lines 14-14 of FIG. 7;

### DETAILED DESCRIPTION OF PREFERRED EMBODIMENT

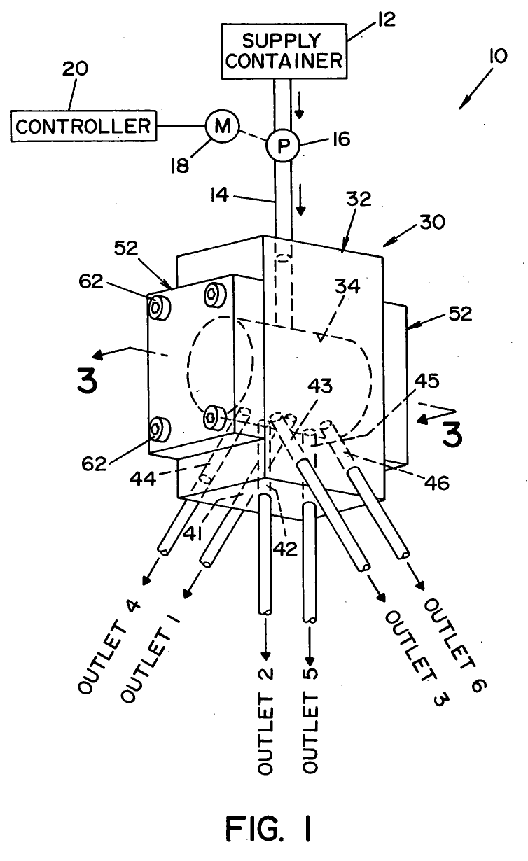

Referring now to the drawings wherein the showings are for the purpose of illustrating a preferred embodiment of the invention only, and not for the purpose of limiting same, FIG. 1 shows a series progressive lubrication metering system 10 for lubricating multiple locations. In accordance with a preferred embodiment of the present invention, system 10 is comprised of a lubricant metering device 30 that is connected to a source of lubricant 12 by a fluid conduit 14. A pump 16, schematically illustrated in FIG. 1, is disposed within fluid conduit 14 to provide lubrication under pressure to the lubricant metering device 30. Pump 16 is driven by a motor 18 (schematically illustrated in FIG. 1), which in turn is controlled by a controller 20. By way of example, and not limitation, motor 18 may be a pneumatic motor, an electric motor or a hydraulic motor.

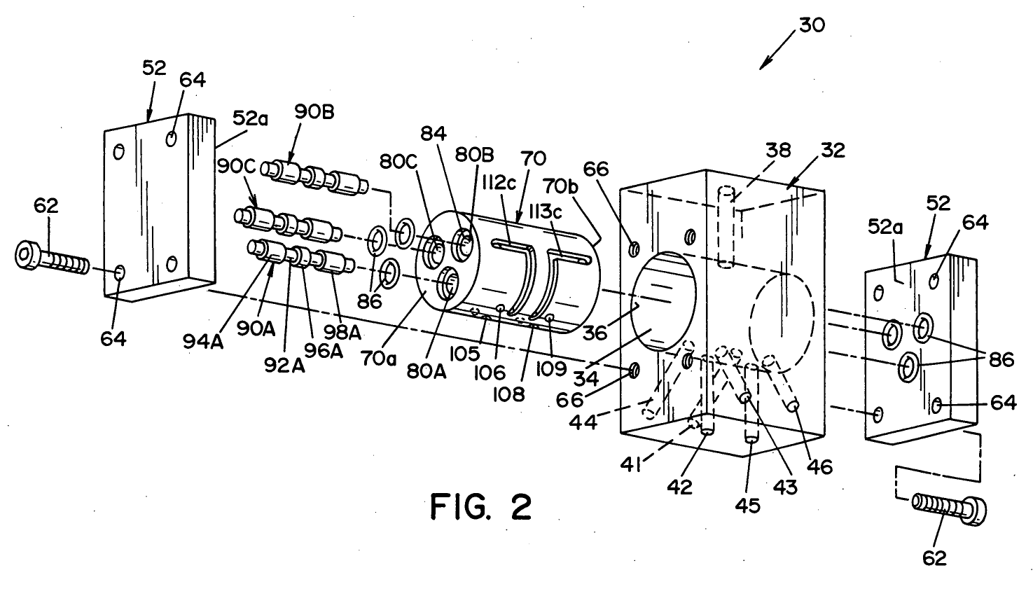

Referring now to FIG. 2, lubricant metering device 30 is best seen. Lubricant metering device 30 includes a housing 32 having an opening 34 therein. In the embodiment shown, housing 32 is rectangular in shape, and opening 34 is cylindrical in shape, and defines a cylindrical inner surface 36. An inlet port 38 is formed in housing 32, and communicates with opening 34. A plurality of outlet ports 41, 42, 43, 44, 45, 46 are formed in housing 32 and communicate with opening 34. In the embodiment shown, six (6) outlet ports are formed in housing 32. As will be appreciated from a further reading of this specification, lubricant metering device 30 may include additional outlet ports. Housing 32 includes end plates 52 having planar inner surfaces 52a to mate with the ends of housing 32. End plates 52 are designed for attachment to housing 32 by means of conventional fasteners 62 extending through holes 64 in end plates 52 into threaded openings 66 in housing 32.

An insert 70 is dimensioned to be disposed within opening 34 within housing 32. Insert 70 is cylindrical in shape and has a diameter closely matching the diameter of opening 34 in housing 32, as shall be described in greater detail below. Insert 70 has planar ends 70a, 70b and a length that matches the length of opening 34 in housing 32. A plurality of bored openings 80A, 80B, 80C is formed through insert 70. In the embodiment shown, bored openings 80A, 80B, 80C are cylindrical in shape and are parallel to each other. Bored openings 80A, 80B 80C extend in an axial direction through insert 70. Bored openings 80A, 80B, 80C define valve openings to receive valve elements 90A, 90B, 90C. In a preferred embodiment, valve elements 90A, 90B, 90C are identical in shape. Accordingly, only valve element 90A shall be described in detail, it being understood that such description applies equally to valve elements 90B and 90C. Valve element 90A includes a valve stem 92A and three (3) axially spaced lands 94A, 96A, 98A. Valve element 90A is dimensioned to be reciprocally slidable within bored opening 80A.

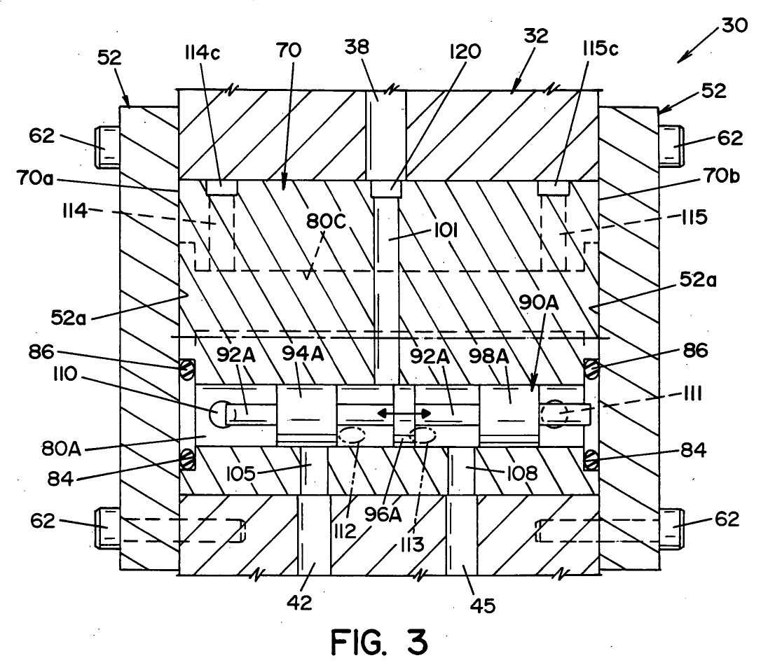

Each end of each bored openings 80A, 80B, 80C is counter-bored to define an annular seat or insert 84 around the ends of bored openings 80A, 80B, 80C. Each annular seat 84 is dimensioned to receive a conventional O-ring 86, as illustrated in FIGS. 2 and 3.

A plurality of fluid passages is formed within the insert. As shall be described in greater detail below, the fluid passages are defined by openings formed into insert 70 and by channels or grooves formed along the surface of insert 70.

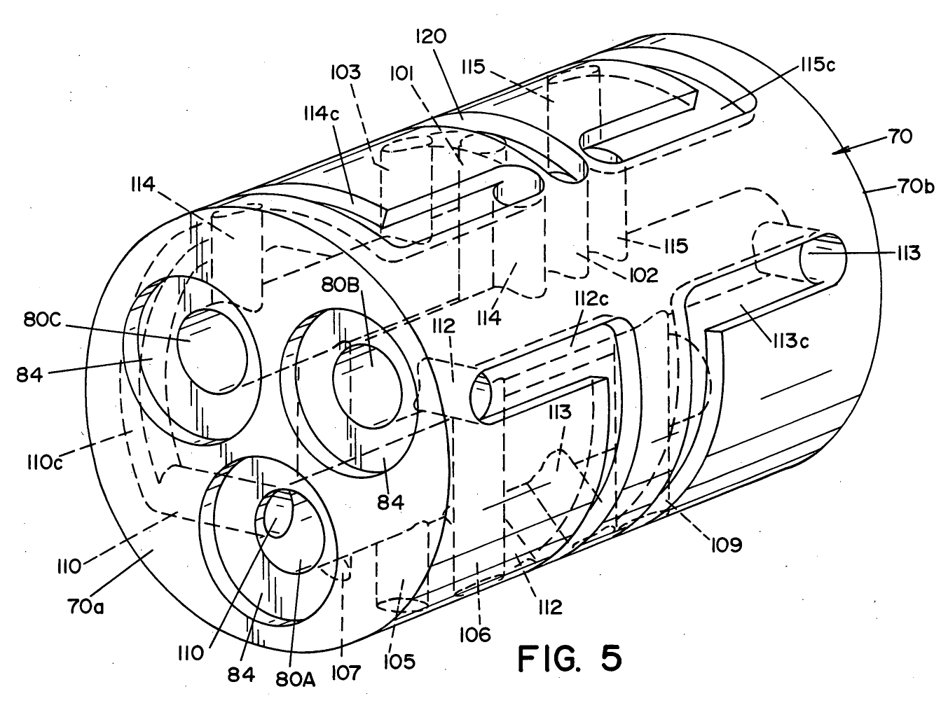

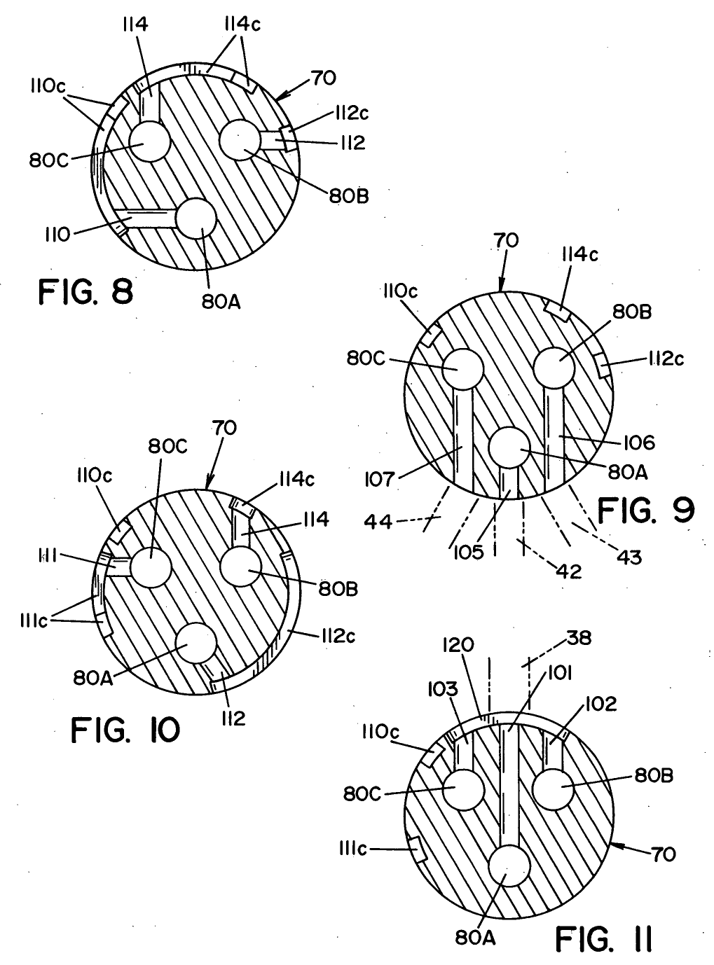

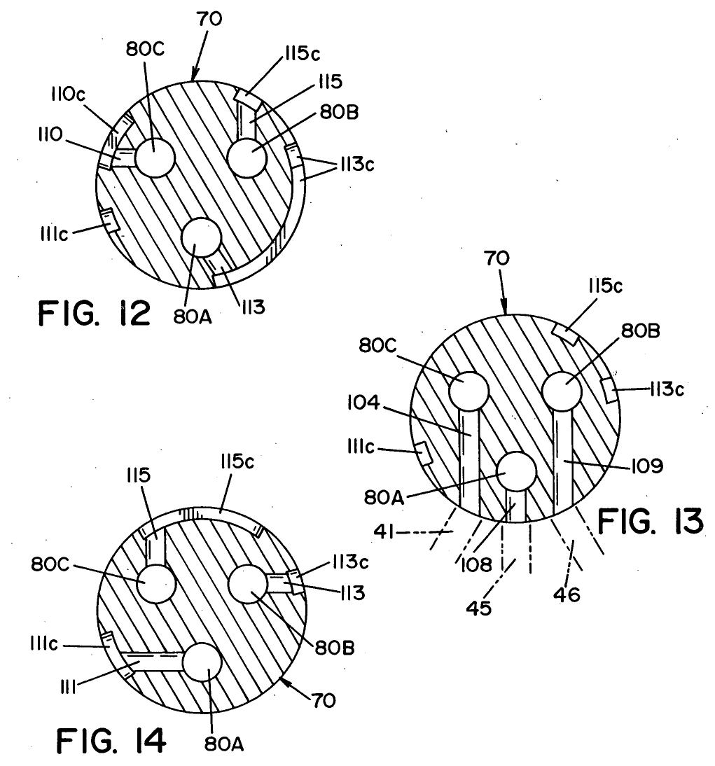

In the embodiment shown, fifteen (15) fluid passages, designated 101, 102, 103, 104, 105, 106, 107, 108, 109, 110, 111, 112, 113, 114 and 115, are formed on or through insert 70. Referring now to FIGS. 5-14, the fluid passages are best seen. The fluid passages include fluid inlet passages 101, 102, 103, fluid outlet passages 104, 105, 106, 107, 108, 109 and valve connecting fluid passages 110, 111, 112, 113, 114, 115.

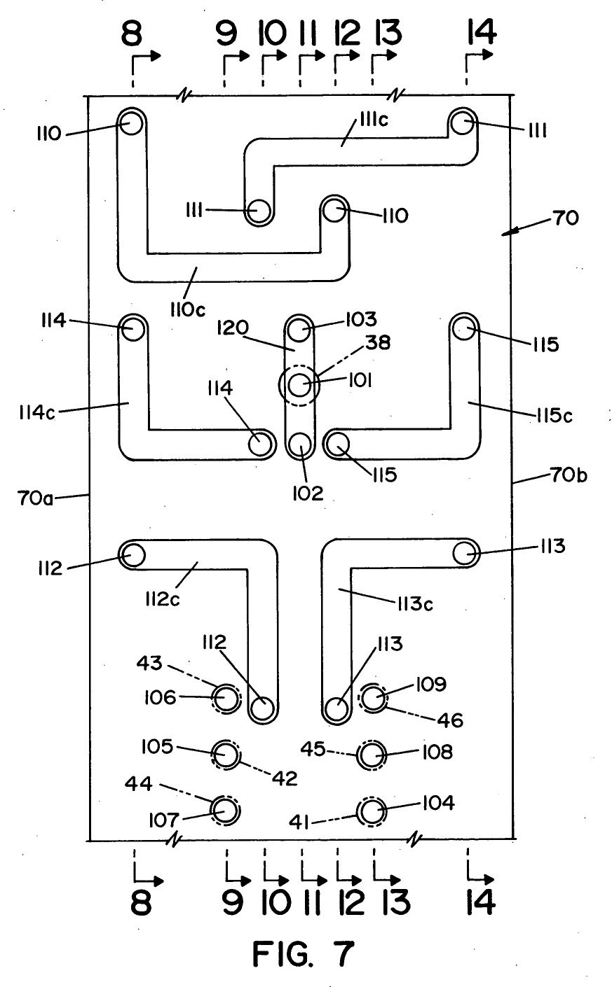

Fluid inlet passages 101, 102, 103 communicate respectively to central portions of bored openings 80A, 80B, 80C, as best seen in FIGS. 7 and 11. A channel 120, best seen in FIG. 7, is formed in the surface of insert 70 connecting each fluid inlet passage 101, 102, 103 to each other. Basically, fluid inlet passages 101, 102, 103 are perpendicular to the axes of bored openings 80A, 80B, 80C.

Fluid outlet passages 104, 105, 106, 107, 108, 109 extend from bored openings 80A, 80B, 80C. As best seen in FIG. 3, fluid outlet passages 105, 108 communicate with bored opening 80A at predetermined locations on opposite sides of fluid inlet passage 101. Similarly, fluid outlet passages 106, 109 communicate with bored opening 80B on opposite sides of fluid inlet passage 102, and a third pair of fluid outlet passages 104, 107 communicate with cylindrical bore 80C on opposite sides of fluid inlet passage 103.

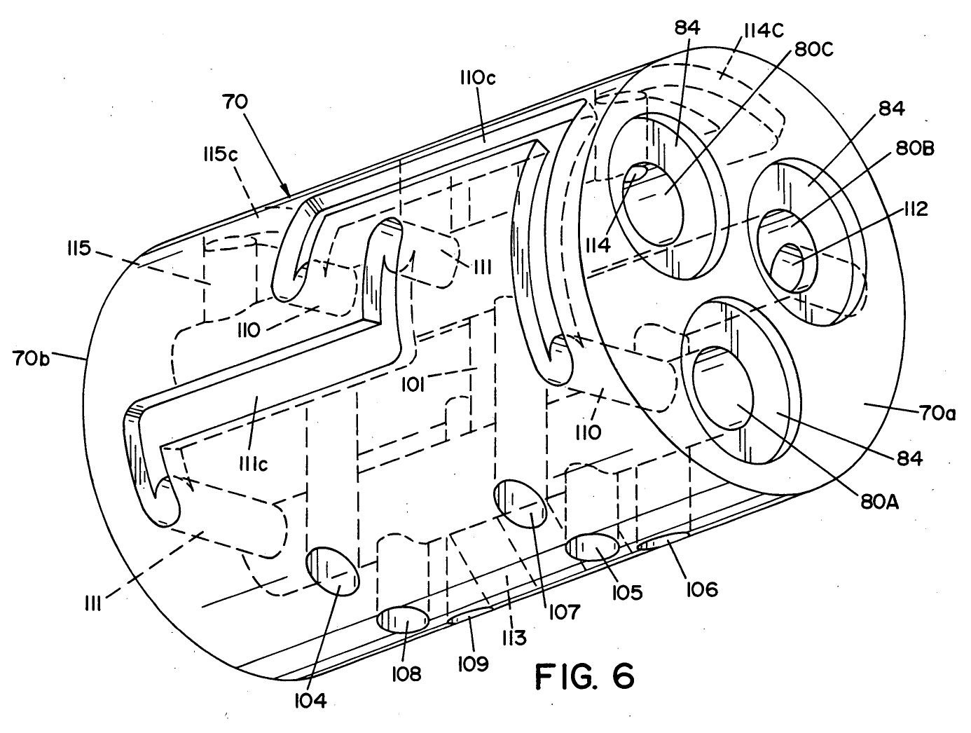

Valve connecting fluid passages 110, 111 connect the outer ends of bored opening 80A to intermediate portions of bored opening 80C, as best seen in FIG. 6. Valve connecting fluid passages 112, 113 connect the intermediate portions of bored opening 80A to the outer ends of bored opening 80B. Valve connecting fluid passages 114, 115 connect the intermediate portions of bored opening 80B to the outer ends of bored opening 80C, as best seen in FIG. 5.

As shown in the drawings, portions 110c, 111c, 112c, 113c, 114c, and 115c of valve connecting fluid passages 110, 111, 112, 113, 114 and 115 are comprised of channels formed in the outer surface of insert 70. Channeled portions 110c, 111c, 112c, 113c, 114c, and 115c connect to fluid passages 110, 111, 112, 113, 114 and 115 formed in insert 70. FIG. 3 shows the relative position of fluid inlet passage 101, fluid outlet passages 105, 108 and valve connecting fluid passages 110, 111, 112 and 113 relative to bored opening 80A and valve element 90A therein. The respective fluid passages connected to bored opening 80B and bored opening 80C are similarly positioned, as illustrated in the drawings.

As indicated above, fluid passages 101 through 115 are formed at predetermined locations relative to bored openings 80A, 80B and 80C and valve elements 90A, 90B, 90C therein. The relative positions of fluid passages 101 through 105 can best be determined with reference to FIGS. 7-14. Fluid inlet passages 101, 102, 103 and fluid outlet passages 104, 105, 106, 107, 108, 109 communicate with the outer surface of insert 70 so as to align with inlet port 38 and outlet ports 41, 42, 43, 44, 45 and 46 that are formed within housing 32, when insert 70 is disposed within housing 32. In this respect, insert 70 is dimensioned to be positioned within opening 34 of housing 32. More specifically, the diameter of insert 70 is such that insert 70 tightly fits within opening 34 of housing 32, such that the outer surface of insert 70 tightly mates with the inner surface of opening 34 in housing 32. As noted above, the fluid passages are disposed on insert 70, and insert 70 is positioned within housing 32 in a predetermined position such that inlet port 38 is in registry with channel 120 and fluid inlet passages 101, 102, 103 in insert 70. Similarly, outlet ports 41, 42, 43, 44, 45, 46 formed in the housing are in registry, respectively, with fluid outlet passages 104, 105, 106, 107, 108 and 109.

The length of insert 70 is preferably the same as the length of opening 34 in housing 32. O-rings 86 are positioned within annular seats 84 formed in the ends of insert 70 such that when end plates 52 are attached to housing 32, fluid-tight seals are formed around each of bored openings 80A, 80B and 80C between end plates 52 and the ends of insert 70.

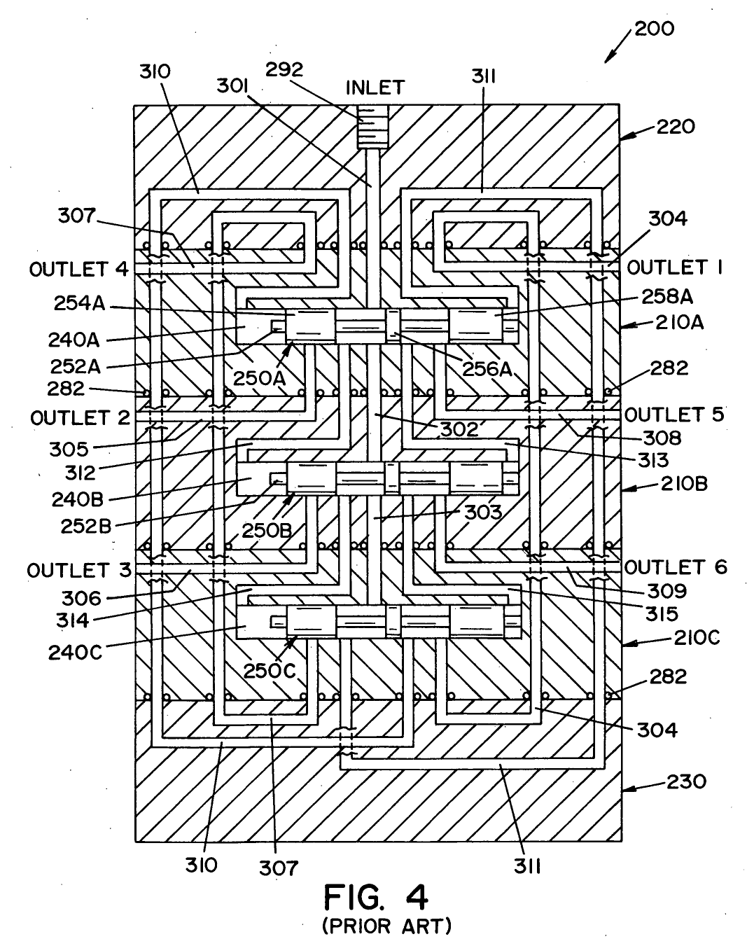

Referring now to FIG. 4, a series progressive lubricant metering device 200 according to the prior art is shown. Metering device 200 is comprised of a plurality of intermediate valve blocks 210A, 2101B, 210C that are sandwiched between an inlet block 220 and an end block 230. Each valve block 210A, 210B, 210C includes a bored opening 240A, 240B, 240C having a movable valve element 250A, 250B, 250C therein. In the embodiment shown, the first intermediate valve block 210A includes a cylindrical bored opening 240A containing a valve element 250A. Valve element 250A includes a central valve stem 252A and three (3) axially spaced lands 254A, 254B and 254C. Valve elements 250B, 250C are basically identical to valve 250A.

As illustrated in the drawings, valve blocks 210A, 210B, 210C, inlet block 220 and end block 230 are machined or otherwise formed to include a plurality of conduits. When the respective blocks are fastened together, a plurality of fluid passages, designated 301, 302, 303, 304, 305, 306, 307, 308, 309, 310, 311, 312, 313, 314, 315 in FIG. 4, are formed. As illustrated in the drawings, O-rings 282 are provided between each valve block 210A, 210B and 210C, and between valve blocks 210A, 210C and inlet block 220 and end block 230, respectively, to fluidly seal the respective blocks to each other and define the aforementioned fluid passages.

Inlet block 220 includes an inlet port 292 that is connectable to a regulated source of pressurized lubricant (not shown). Metering device 200 has six (6) outlets, designated “Outlet 1,” “Outlet 2,” “Outlet 3,” “Outlet 4,” “Outlet 5” and “Outlet 6.” The operation of lubricant metering device 10 may best be understood with reference to the operation of prior art lubrication metering device 200 that operates in a similar fashion and is easier to visualize.

Fluid passages 301, 302, 303 are basically fluid inlet passages connecting inlet port 292 to bored openings 240A, 240B and 240C. Fluid passages 304, 305, 306, 307, 308, 309 are fluid outlet passages connecting the ends of bored openings 240A, 240B, 240C to “Outlet 1” through “Outlet 6.” Fluid passages 310, 311, 312, 313, 314, 315 are valve connecting fluid passages that connect bored openings 240A, 240B, 240C to each other.

Referring now to the operation of metering device 200, FIG. 4 shows each of valve element 250A, 250B, 250C positioned to the right side of its respective valve opening 240A, 240B, 240C. When pressurized lubricant is applied to inlet port 292 of metering device 200, the pressurized lubricant flows through fluid passage 301 around valve stem 252A to fluid passage 302, around valve stem 252B to fluid passage 303, and then into bored opening 240C. Bored opening 240C communicates with fluid passage 311 that extends from bored opening 240C to the right-hand side of bored opening 240A. The pressurized lubricant in fluid passage 311 causes valve element 250A to move to the left in bored opening 240A. Movement of valve element 250A to the left causes any lubricant in front of valve element 250A to be forced into fluid passage 310 that communicates with fluid passage 304 through bored opening 240C. The lubricant is then forced through fluid passage 304 to Outlet 1.

As valve element 250A moves to the left, fluid passage 301 comes into fluid communication with fluid passage 313. This causes valve element 250B to move to the left in bored opening 240B. As valve element 250B moves to the left, it forces any lubricant in front of it into fluid passage 312. Since valve element 250A has been moved to the left end of bored opening 240A, fluid passage 312 communicates with fluid passage 305 through bored opening 240A to force the lubricant out through Outlet 2.

Movement of valve element 250B to the left causes fluid passages 301 and 302 to communicate with fluid passage 315 that causes valve element 250C to move to the left. As valve element 250C moves to the left, any lubricant fluid in front of valve element 250C is forced into fluid passage 314. Since valve element 250B has been moved to the left of bored opening 240B, fluid passage 314 communicates with fluid passage 306 to force the lubricant out through Outlet 3. As valve element 250C moves to the left in bored opening 240C, fluid passages 301, 302, 303 move into fluid communication with fluid passage 310 that conveys pressurized lubricant to the left-hand side of valve element 250A. As a result, valve element 250A is pushed back to the right-hand side of bored opening 240A. Lubricant in front of, i.e., to the right, of valve element 250A is forced into fluid passage 311. With valve element 250C having been moved to the left end of bored opening 240C, pressurized lubricant in fluid passage 311 communicates with fluid passage 307 that conveys the lubricant out through Outlet 4. With valve element 250A moved back to the right end of bored opening 240A, pressurized lubricant in fluid passage 301 communicates with fluid passage 312 which forces valve element 250B to the right. Fluid in front of valve element 250B is forced into fluid passage 313, which communicates with fluid passage 308 through bored opening 240A, and is forced out through Outlet 5. With valve element 250B being moved to the right end of bored opening 240B, pressurized fluid from fluid passages 301 and 302 communicates with fluid passage 314. Pressurized lubricant forces valve element 250C to the right end of bored opening 240C. Lubricant ahead of valve element 250C is thus forced into fluid passage 315, through fluid passage 309 via bored opening 240B to Outlet 6.

With valve elements 250A, 250B, 250C all returned to the right end of their respective bored openings 240A, 240B, 240C, continued pressure at inlet port 292 will repeat the foregoing cycle and will progressively meter lubricant to the six (6) Outlets in the sequence described above.

The fluid passages in insert 70, according to the present invention, are designed to operate in a similar fashion as just described. Whereas the prior art requires numerous blocks 210A, 210B, 210C, 220, 230 having intricate machining in each of the blocks, and further requires blocks 210A, 210B, 210C, 220, 230 to be sealed to each other to maintain the integrity of the respective fluid passages, the present invention provides a single insert 70 having the respective fluid passages formed therein. The fluid passages are defined by bores communicating from the outer surface of insert 70 to the respective valve openings, and through channels formed in the outer surface of insert 70. When insert 70 is inserted into housing 32, inner surface 36 of opening 34 in housing 32 seals the channels, thus completing and isolating the respective fluid passages. Lubricant metering device 30 thus provides a more compact structure that is easier and less costly to produce, has less moving parts and that is easier to assemble. Moreover, lubricant metering device 30 can be incorporated into a machine part by forming opening 34 within a portion of housing 32 in the machine part. In this respect, insert 70, as part of series progressive metering device 30, can be incorporated into a machine part thereby reducing the connection lines and attachment parts to the lubrication point.

In the embodiment shown, lubricant metering device 30 includes six (6) outlet ports. As will be appreciated by those skilled in the art, the number “N” of outlet ports is related to the number of valve elements 90 within insert 70. In this respect, the number “N” of outlet ports is twice the number “n” of valve elements 90. It will also be appreciated that lubricant metering device 30 can be designed to include more than three (3) valve elements. Additional valve elements and outlet ports may be provided by utilizing the basic design discussed above.

In addition, it will be appreciated that the lubricant output during each cycle is based upon the length of bored openings 80A, 80B, 80C and the travel of valve elements 90A, 90B, 90C. It is contemplated that valve elements 90 are removable and may be replaced with different sized (i.e., length) valve elements to vary the output of lubricant during each cycle.

In the embodiment, housing 32 and insert 70 are formed of a metal, namely, steel, wherein the openings and fluid passages in housing 32 and insert 70 are machined. As will be appreciated, housing 32 and insert 70 may be formed of other metals, such as by way of example and not limitation, aluminum, stainless steel, brass, bronze or alloys thereof. Housing 32 and insert 70 may be formed of a cast metal. It is also contemplated that the insert may be formed of a molded ceramic material. A molded thermoplastic, an engineered thermoplastic, a thermoset or a polymer containing a filler are likewise contemplated.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A lubricant metering device, comprised of:
a housing having an opening formed therein, said housing having an inlet port communicating with said opening and a plurality of outlet ports communicating with said opening;
an insert disposed within said opening;
a plurality of valve spools within said insert, each valve spool being reciprocally movable within a bore in said insert; and
fluid passages formed in said insert, said fluid passage connecting said inlet port in said housing to each bore in said insert, connecting each bore to the other bore in said insert, and connecting each bore to at least one outlet port in said housing, wherein each spool will move in sequence to dispense a metered quantity of lubricant to an outlet port, as long as lubricant under pressure is applied to said inlet port.

2. A lubricant metering device as defined in claim 1, wherein each of said bores includes fluid circuitry connecting each end of said bore to an outlet port in said housing.

3. A lubricant metering device as defined in claim 1, wherein said fluid circuitry in said insert is comprised of openings extending into said insert and channels formed along the surface of said insert.

4. A lubricant metering device as defined in claim 3, wherein said channels in said insert form fluid passages when said insert is disposed within said housing.

5. A lubricant metering device as defined in claim 1, wherein said cavity in said housing is cylindrical in shape and said insert is cylindrical in shape.

6. A lubrication metering device as defined in claim 5, wherein said insert is press fit into said housing.

7. A progressive, sequential lubricant metering device, comprised of:
a housing having an opening formed therein, said opening defining an inner surface within said housing;
a fluid inlet in said housing communicating with said opening;
“N” number of fluid outlets in said housing communicating with said opening; and
an insert disposed within said opening in said housing, said insert having “n” number of bored openings formed therein, where “N” is twice “n”;
a reciprocally movable valve element in each of said bored openings; and
a plurality of fluid passages connecting each bored opening to the other bored opening and connecting each bored opening to a fluid outlet, wherein each of said valve elements will move in sequence to dispense a metered quantity of lubricant to an outlet, as long as lubricant under pressure is applied to said inlet port.
